(19) United States
(12) Patent Application Publication
(10) Pub. No.: US 2020/0105103 A1
(43) Pub. Date: Apr. 2, 2020

(54) GAME SYSTEM WITH ADDITIONAL BETS AND ODDS FOR EXTRA PAYOUTS

(71) Applicant: JUMBO TECHNOLOGY CO., LTD., Taichung (TW)

(72) Inventors: Shun-Tsung HSU, Taichung (TW); Chang-Yi WANG, Taichung (TW); Yen-Chih WU, Taichung (TW)

(21) Appl. No.: 16/144,229

(22) Filed: Sep. 27, 2018

(51) Int. Cl. G07F 17/32

(52) U.S. Cl. CPC G07F 17/3267; G07F 17/323; G07F 17/3288

(57) ABSTRACT

The present invention mainly includes a score determination unit determining whether a game score of a player satisfies a score threshold value and accordingly generating a score determination signal. A processing unit determines whether to enable an additional bet option according to the score determination signal, and then the processing unit controls a game status display unit to display an enabled status of the additional bet option. When the additional bet option is in the enabled status, the player selects to bet to generate an additional bet signal, and the processing unit controls an odds generation unit to generate at least one of additional random odds. Therefore, the player obtains payouts of the additional random odds.

### FIELD OF THE INVENTION

The present invention relates to game system, and more particularly to a game system with additional bets and odds for extra payouts.

### BACKGROUND OF THE INVENTION

Game systems have a variety of styles, with which a variety of games are played, such as slot machines, poker games, SicBo shakers (dice) and roulettes, etc., so they are widely welcomed by players and operators. Although game systems with a dealer (real person) are more lively and vivid, its labor cost is high, and someone is likely to cheat. Game systems without a dealer (real person) have the disadvantage of being a mechanical response, which makes it easy for people to feel monotonous and without changes. Therefore, in order to avoid the stereotyped ways of playing, and prevent the player from losing interest in the game in a short time, there are many ways to attract players.

For example, U.S. Pat. No. 9,646,459 B2, “Incentive Apparatus for Gambling Game Systems”, enhances the variability of a game while attracting the attention of a player by displaying a dynamic raised odds of additional stakes on an electronic display board, thereby reducing the player's fatigue.

However, under the premise of retaining the profits of operators, in actual use, a probability of occurrence and a quantity of the dynamic raised odds of additional stakes are quite limited. Increase in the probability of occurrence and quantity is only possible by reducing a value of the raised odds of additional stakes. It is not incentive and yet one would hesitate to discard it, and cannot achieve the effectiveness of attracting the attention of the player to place bets.

### SUMMARY OF THE INVENTION

Therefore, a main object of the present invention is to provide a game system with additional bets and odds for extra payouts, which attracts a player's attention by enabling and displaying an additional bet option. At the same time, by allowing the player to make additional bets, thereby increasing a probability of occurrence and a value of an additional random odds, and maintaining the player's interest to continue to bet, in order to increase a turnover of the game system.

Based on the above object, the present invention provides a game system with additional bets and odds for extra payouts provided for a player to play a game. The game has a plurality of game results, and the player has a game score. The game system comprises a game result generation unit, a score determination unit, a game status display unit, a bet unit, an odds generation unit, a payout unit and a processing unit, wherein the game result generation unit randomly generates any one of the plurality of game results for each round of the game, the score determination unit is used to determine whether the game score satisfies a score threshold value and accordingly generates a score determination signal. The game status display unit includes a game display field for displaying a real-time game status, a plurality of bet boxes corresponding to the plurality of game results, and a status display field, and each of the plurality of bet boxes has a basic odds.

The bet unit is provided for the player to place bets in the plurality of bet boxes to generate a bet amount signal, and the bet unit has an additional bet option with an enabled status that is able to be changed, when the additional bet option is in the enabled status, the player selects whether to place additional bets and causes the bet unit to generate an additional bet signal. The odds generation unit generates a random odds for at least one of the plurality of bet boxes, and generates an additional random odds for at least one of the plurality of bet boxes according to the additional bet signal. Each of the bet boxes has an actual odds, the actual odds is respectively corresponds to the basic odds of the plurality of bet boxes, and when both the random odds and the additional random odds are generated, the actual odds are further replaced with a new value according to the random odds and the additional random odds. The payout unit pays according to the plurality of game results generated by the game result generation unit, the bet amount signal of the player and the actual odds of the plurality of bet boxes, and accumulates to the game score.

The processing unit is connected to the odds generation unit, the game result generation unit, the score determination unit, the bet unit, the game status display unit and the payout unit. The processing unit controls a progress of the game, and the processing unit is preferably embodied following steps of: S1: the processing unit controlling the game status display unit to notify the player to start placing the bets so that the bet unit generating the bet amount signal, and the game status display unit displaying bet amounts corresponding to the bet amount signal, in the plurality of bet boxes; S2: the processing unit controlling the score determination unit to generate the score determination signal and to transmit the score determination signal back to the processing unit; S3: the processing unit determining whether to enable the additional bet option according to the score determination signal and controlling the game status display unit to display the enabled status of the additional bet option in the status display field, when the additional bet option being in the enabled status, the plurality of bet boxes provided for the player to select whether to place the additional bets and causing the bet unit to generate the additional bet signal, and the processing unit controlling the game status display unit to display the additional bets corresponding to the additional bet signal, in the plurality of bet boxes; S4: after the player ending the bet, the processing unit controlling the odds generation unit to generate the random odds and controlling the odds generation unit to generate the additional random odds when the bet unit generating the additional bet signal, and the game status display unit displaying the random odds and the additional random odds in the plurality of bet boxes; S5: the processing unit controlling the game result generation unit to generate any one of the plurality of game results; and S6: the processing unit controlling the payout unit to pay.

Alternatively, another embodiment of the processing unit performs following steps of: P1: the processing unit controlling the game status display unit to notify the player to start placing the bets so that the bet unit generating the bet amount signal, and the game status display unit displaying bet amounts corresponding to the bet amount signal, in the plurality of bet boxes; P2: after the player ending the bet, the processing unit controlling the score determination unit to generate the score determination signal and to transmit the score determination signal back to the processing unit, the processing unit simultaneously controlling the odds generation unit to generate the random odds, and the processing unit controlling the game status display unit displaying the random odds in the plurality of bet boxes; P3: the processing unit determining whether to enable the additional bet option according to the score determination signal and the processing unit controlling the game status display unit to display the enabled status of the additional bet option in the status display field, when the additional bet option being in the enabled status, the player selecting whether to place the bets and causing the bet unit to generate the additional bet signal, and the game status display unit displaying additional bets corresponding to the additional bet signal, in the plurality of bet boxes; P4: after the bet unit generating the additional bet signal, the processing unit controlling the odds generation unit to generate the additional random odds, and the game status display unit displaying the additional random odds in the plurality of bet boxes; P5: the processing unit controlling the game result generation unit to generate any one of the plurality of game results; and P6: the processing unit controlling the payout unit to pay.

Accordingly, in the two embodiments described above, the player is reminded to place additional bets by first determining whether the game score is sufficient, and then the additional bet option is enabled by the processing unit and the game status display unit display the additional bet option. Further, when the player places the additional bets, a probability of occurrence and a quantity of the additional random odds is increased, which increase the uncertainty and fun of the game, and indeed increase an effectiveness of attracting the attention of the player to place the bets.

### BRIEF DESCRIPTION OF THE DRAWINGS

FIG. 1 is a functional block diagram of a game system of the present invention;

FIG. 2 is a flow chart of an operation of a first embodiment of the present invention;

FIG. 3 is a schematic diagram of a physical machine of the game system of the present invention;

FIG. 4A is a first schematic diagram of an implementation of a game status display unit of the present invention;

FIG. 4B is a second schematic diagram of an implementation of the game status display unit of the present invention;

FIG. 4C is a third schematic diagram of an implementation of the game status display unit of the present invention;

FIG. 5 is a first architecture diagram of the game system of the present invention;

FIG. 6 is a schematic diagram of another physical machine of the game system of the present invention;

FIG. 7A is a first schematic diagram of another implementation of the game status display unit of the present invention;

FIG. 7B is a second schematic diagram of another implementation of the game status display unit of the present invention;

FIG. 8 is a flow chart of an operation of a second embodiment of the present invention;

FIG. 9 is a second architecture diagram of the game system of the present invention; and

FIG. 10 is a third architecture diagram of the game system of the present invention.

### DETAILED DESCRIPTION OF THE PREFERRED EMBODIMENTS

The details and technical description of the present invention are further illustrated by the following embodiments.

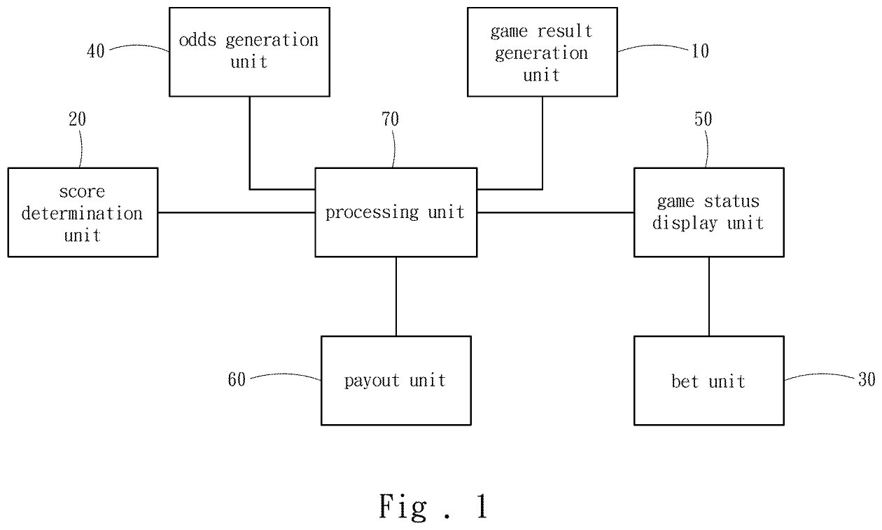

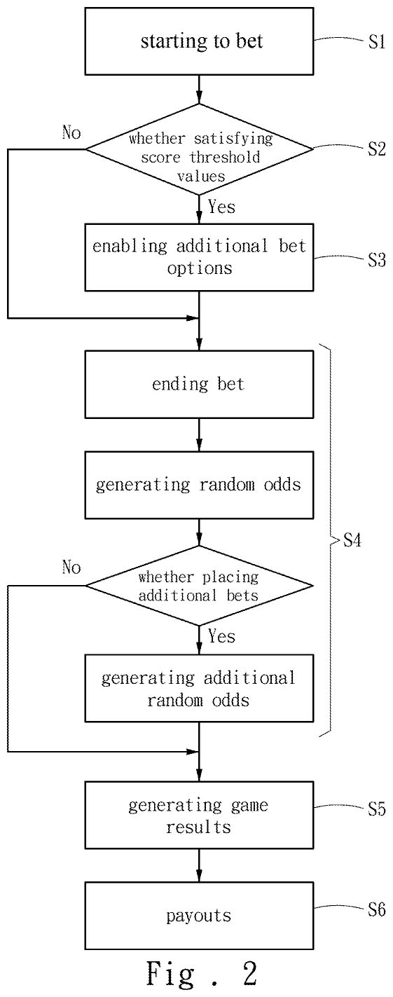

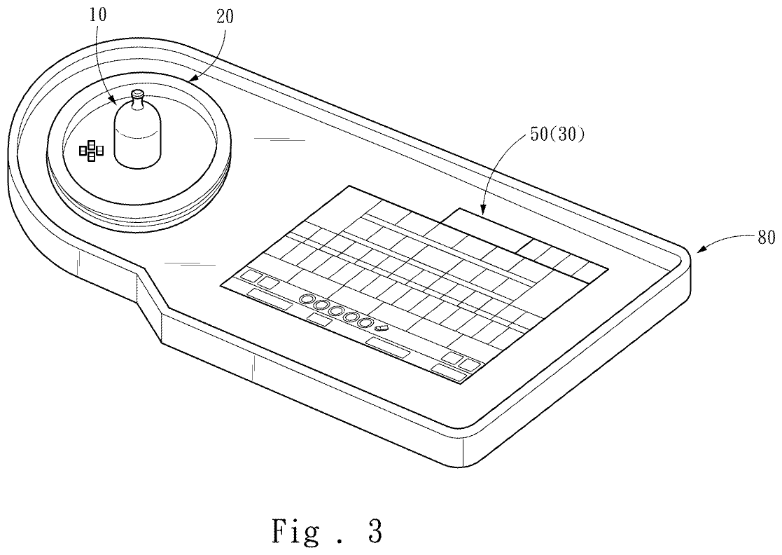

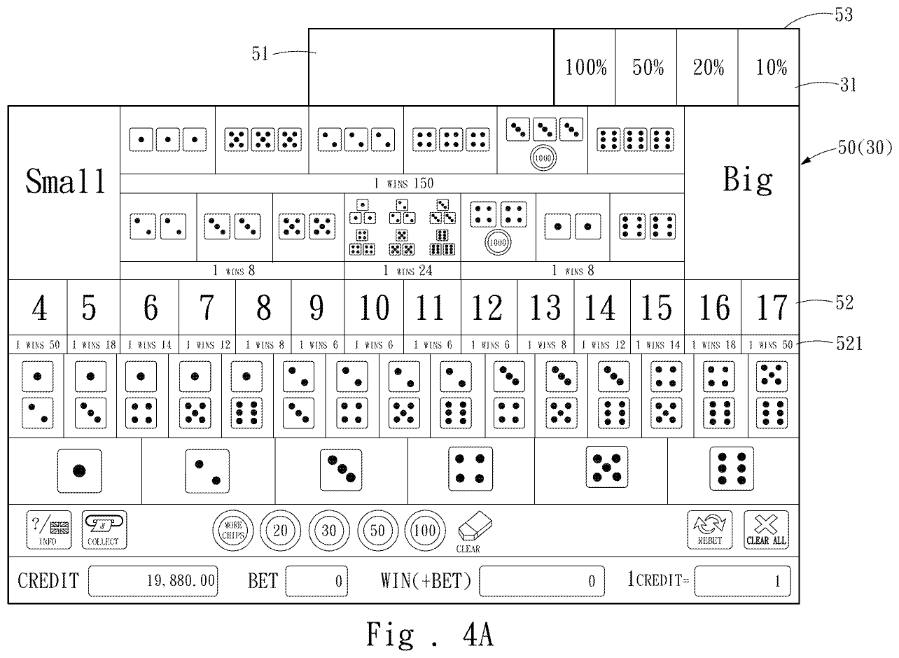

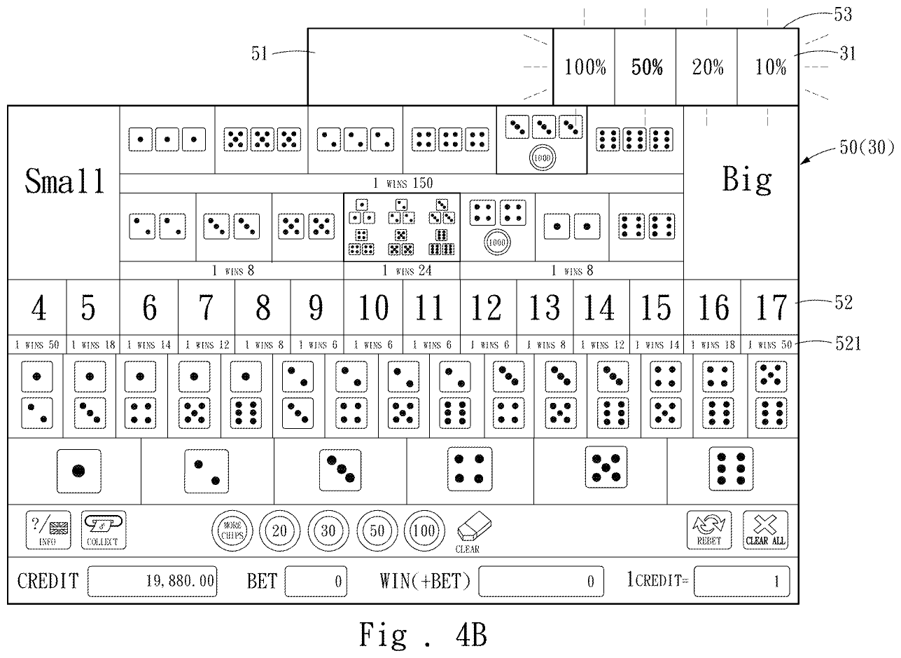

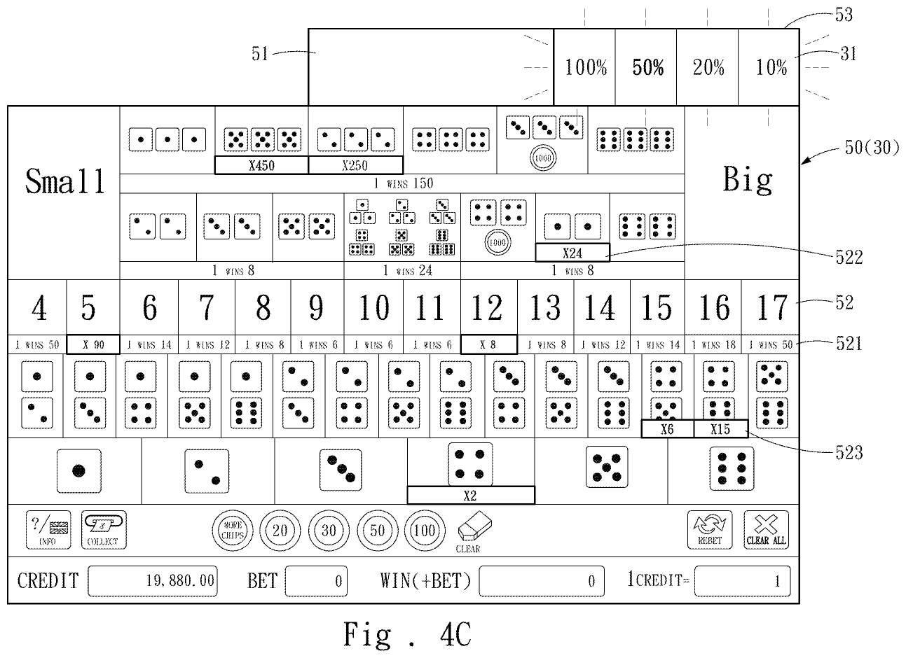

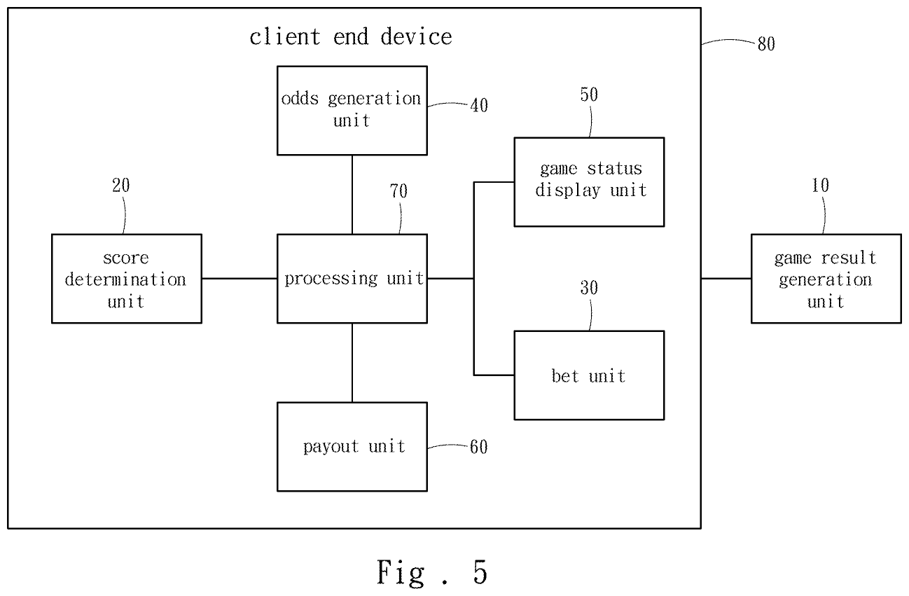

The present invention is implemented in a physical machine, such as implemented in a game of SicBo shaker. Please refer to FIG. 1, FIG. 2, FIG. 3, FIG. 4A and FIG. 5. The present invention is a game system with additional bets and odds for extra payouts, which is provided for a player to play a game. The game has a plurality of game results, and the player has a game score. The game system comprises a game result generation unit 10, a score determination unit 20, a bet unit 30, an odds generation unit 40, a game status display unit 50, a payout unit 60 and a processing unit 70, wherein the game result generation unit 10 randomly generates any one of the plurality of game results for each round of the game.

As shown in FIG. 3 and FIG. 5, the game result generation unit 10 is a machine device with a physical body, such as a dice that is automatically shaken. The score determination unit 20, the bet unit 30, the odds generation unit 40, the game status display unit 50, the payout unit 60, and the processing unit 70 are disposed in a client end device 80. The client end device 80 is connected to the game result generation unit 10 to cause the processing unit 70 to obtain the plurality of game results generated by the game result generation unit 10.

The score determination unit 20 is used to determine whether the game score satisfies a score threshold value, and to generate a score determination signal accordingly. The score threshold value is equal to a required score for an additional bet. In other words, the score determination signal generated by the score determination unit 20 is “Yes” and “No”. When the game score exceeds the required score for the additional bet, the score determination signal is “Yes”. When the game score not exceeds the required score for the additional bet, the score determination signal is “No”.

As shown in FIG. 4A, the game status display unit 50 includes a game display field 51 for displaying a real-time game status, a plurality of bet boxes 52 corresponding to the plurality of game results, and a status display field 53. Each of the plurality of bet boxes 52 has a filter condition, which is corresponded when the game result is satisfied. In other words, each of the plurality of bet boxes 52 corresponds to at least one of the plurality of game results, and the different bet boxes 52 are able to correspond to the same game result. Each of plurality of bet boxes 52 has a basic odds 521. The bet unit 30 is provided for the player to place bets in the plurality of bet boxes 52 to generate a bet amount signal.

As shown in FIG. 3 and FIG. 4A, the bet unit 30 and the game status display unit 50 are applied to a touch screen, and the bet unit 30 has an additional bet option 31 with an enabled status that is able to be changed. When the additional bet option 31 is in the enabled status, the player selects whether to place additional bets and causes the bet unit 30 to generate an additional bet signal. A quantity of the additional bet option 31 of the bet unit 30 is a plurality, the additional bet options 31 are respectively corresponding to the additional bet signals of different additional bets, and the additional bet options 31 include different score threshold values. The score determination unit 20 determines the score threshold value one by one, and causes the processing unit 70 to enable the additional bet options 31 that satisfy the score threshold value for the player to select any one of the additional bet options 31. In order to facilitate the player to directly control the bet amount, each of the additional bet values of the additional bet signal is a specified percentage of the bet amount of the bet amount signal, such as 10%, 20%, 50% and 100%, and the like.

Please refer to FIG. 1 and FIG. 4C as well. The odds generation unit 40 generates a random odds 522 for at least one of the plurality of bet boxes 52 after the player placing the bets, and generates an additional random odds 523 for at least one of the plurality of bet boxes 52 according to the additional bet signal. A quantity of the plurality of bet boxes 52 is positively correlated to the additional bet of the additional bet signal corresponding to the additional bet options 31 selected by the player. In other words, the higher the additional bet values, the higher the probability of the quantity of the additional random odds 523 is displayed by the plurality of the bet boxes 52, in order to encourage the player to place the additional bets.

In addition, each of the plurality of bet boxes 52 has an actual odds, and the actual odds respectively corresponds to the basic odds 521 of the plurality of bet boxes 52. When both the random odds 522 and the additional random odds 523 are generated, the actual odds are further replaced with a new value according to the random odds 522 and the additional random odds 523. That is, the actual odds are added and replaced by the random odds 522 and the additional random odds 523 with the basic odds 521; or the actual odds is replaced by the sum of the random odds 522 and the additional random odds 523. The payout unit 60 pays according to the plurality of game results generated by the game result generation unit 10, the bet amount signal of the player and the actual odds of the plurality of bet boxes 52, and accumulates to the game score.

Please refer to FIG. 2 and FIG. 4B. The processing unit 70 is connected to the odds generation unit 40, the game result generation unit 10, the score determination unit 20, the bet unit 30, the game status display unit 50 and the payout unit 60. The processing unit 70 controls a progress of the game, and the processing unit 70 is preferably embodied following steps.

S1: The processing unit 70 controls the game status display unit 50 to notify the player to start placing the bets so that the bet unit 30 generates the bet amount signal, and the game status display unit 50 displays bet amounts corresponding to the bet amount signal (as shown in FIG. 4A) in the plurality of bet boxes 52.

S2: The processing unit 70 controls the score determination unit 20 to generate the score determination signal and to transmit the score determination signal back to the processing unit 70.

S3: The processing unit 70 determines whether to enable the additional bet option 31 according to the score determination signal. More specifically, the additional bet option 31 is enabled when the score determination signal is “Yes”, and the additional bet option 31 is not enabled when the score determination signal is “No”. Further, the processing unit 70 controls the game status display unit 50 to display the enabled status of the additional bet option 31 in the status display field 53. In order to attract the attention of the player, the status display field 53 of the game status display unit 50 has a reminder mode, the status display field 53 starts the reminder mode when the additional bet option 31 is enabled. The reminder mode is displayed by illuminating (as shown in FIG. 4B), highlighting, flashing, contrasting color, etc. When the additional bet option 31 is in the enabled status, the plurality of bet boxes 52 are provided for the player to select whether to place the additional bets and causes the bet unit 30 to generate the additional bet signal, and the processing unit 70 controls the game status display unit 50 to display the additional bets corresponding to the additional bet signal in the plurality of bet boxes 52 (as shown in FIG. 4B, 50% is indicated in bold font).

S4: After the player ends the bets, the processing unit 70 controls the odds generation unit 40 to generate the random odds 522 after the player ending the bets and controls the odds generation unit 40 to generate the additional random odds 523 when the bet unit 30 generates the additional bet signal. The game status display unit 50 displays the random odds 522 and the additional random odds 523 in the plurality of bet boxes 52 (as shown in FIG. 4C).

S5: The processing unit 70 controls the game result generation unit 10 to generate any one of the plurality of game results.

S6: The processing unit 70 controls the payout unit 60 to pay.

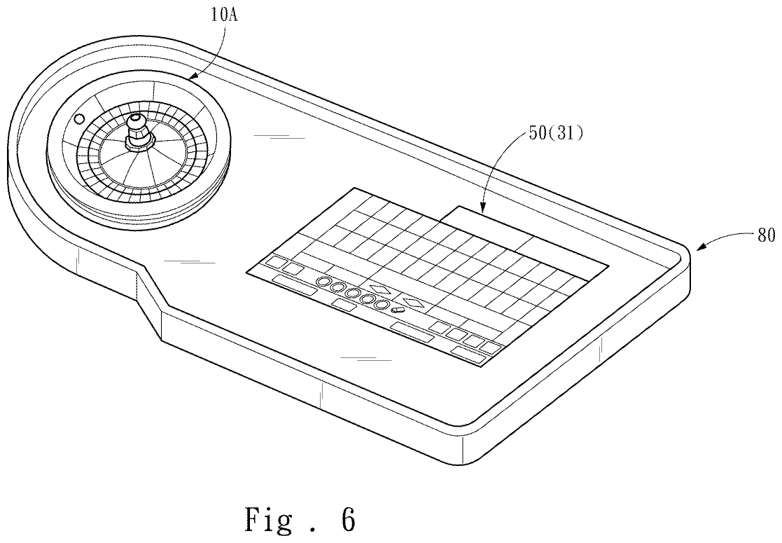

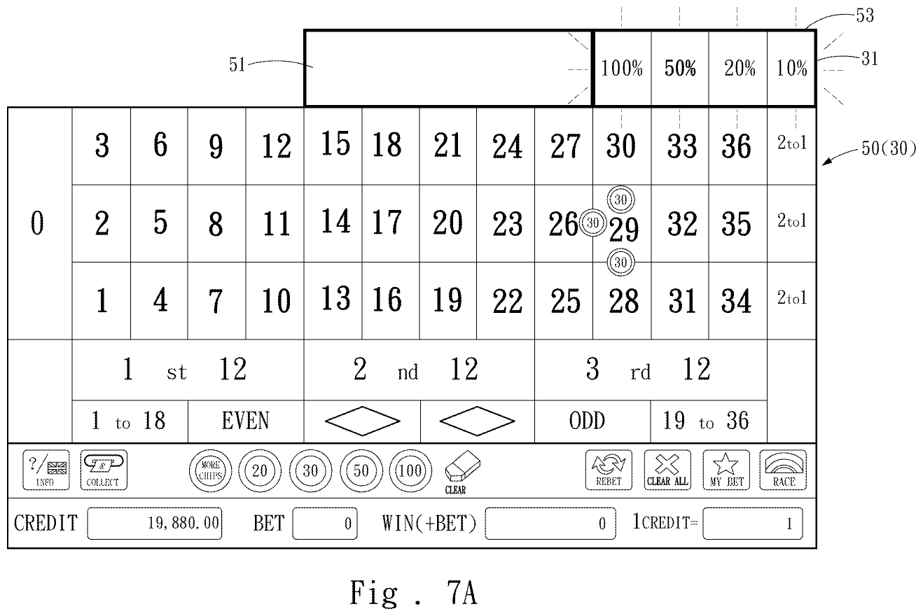

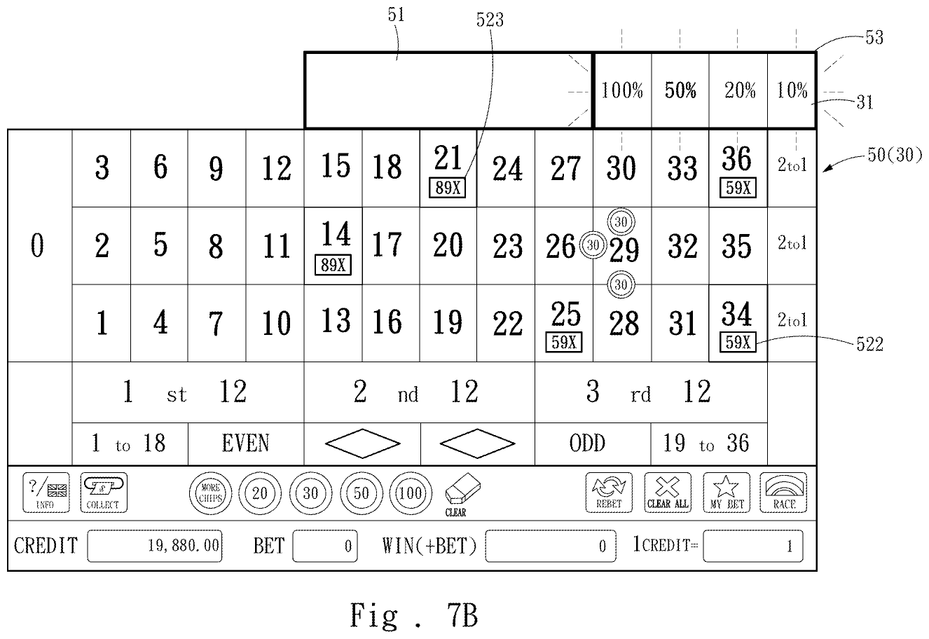

Please refer to FIG. 6, FIG. 7A and FIG. 7B, which are schematic diagrams of the present invention being implemented in a physical machine of roulette and the game status display unit respectively. As shown in the figures, a game result generation unit 10A is a roulette and is connected to the client end device 80. The bet unit 30 and the game status display unit 50 are applied to a touch screen. The game display field 51, the plurality of bet boxes 52, and the status display field 53 of the game status display unit 50 are disposed correspondingly to the roulette.

Similarly, when the additional bet option 31 is in the enabled status, the reminder mode is started and displayed by illuminating (as shown in FIG. 7A), highlighting, flashing, contrasting color, etc., so as to attract the attention of the player. After the random odds 522 and the additional random odds 523 are generated by the odds generation unit 40, the game status display unit 50 displays the random odds 522 and the additional random odds 523 in the plurality of bet boxes 52 (as shown in FIG. 7B).

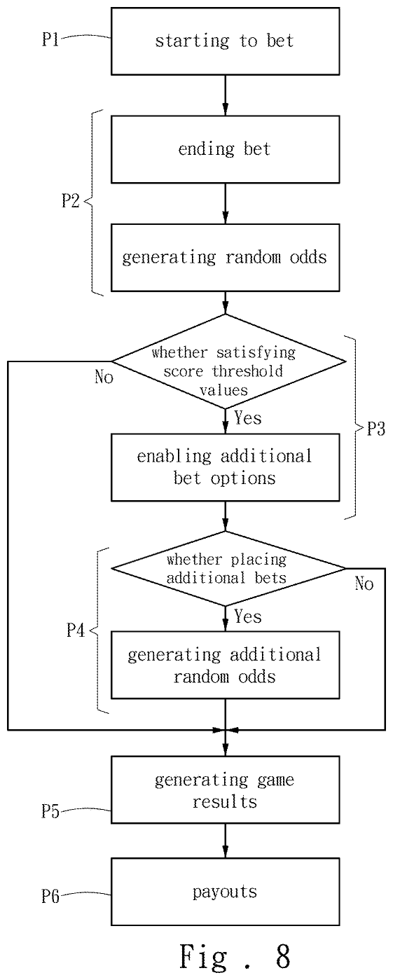

Please refer to FIG. 1 and FIG. 8, another preferred embodiment of the processing unit 70 is to perform following steps.

P1: The processing unit 70 controls the game status display unit to notify the player to start placing the bets so that the bet unit 30 generates the bet amount signal, and the game status display unit 50 displays bet amounts corresponding to the bet amount signal, in the plurality of bet boxes 52.

P2: After the player ends the bets, the processing unit 70 controls the score determination unit 20 to generate the score determination signal and to transmit the score determination signal back to the processing unit 70. Simultaneously, the processing unit 70 controls the odds generation unit 40 to generate the random odds 522 and the processing unit 70 controls the game status display unit 50 to display the random odds 522 in the plurality of bet boxes 52.

P3: The processing unit 70 determines whether to enable the additional bet option 31 according to the score determination signal, and the processing unit 70 controls the game status display unit 50 to display the enabled status of the additional bet option 31 in the status display field 53. When the additional bet option 31 is in the enabled status, the player selects whether to place the additional bets and causes the bet unit 30 to generate the additional bet signal, and the game status display unit 50 displays the additional bets corresponding to the additional bet signal in the plurality of bet boxes 52.

P4: After the bet unit 30 generates the additional bet signal, the processing unit 70 controls the odds generation unit 40 to generate the additional random odds 523, and the game status display unit 50 displays the additional random odds 523 in the plurality of bet boxes 52.

P5: The processing unit 70 controls the game result generation unit 10 to generate any one of the plurality of game results.

P6: The processing unit 70 controls the payout unit 60 to pay.

In comparison with an operational flowchart of FIG. 2, the features of this embodiment is that after the random odds 522 is generated by the odds generation unit 40, the processing unit 70 determines whether to enable the additional bet option 31 according to the score determination signal. Therefore, the player decides whether to place the additional bet according to odds and a quantity of the random odds 522, and the player may have a feeling of being in an advantageous position, thereby increasing the possibility of placing the additional bets, and further increasing the amount of bets.

As described above, the game result generation unit 10 is applied to various games other than selected from any one of roulette and SicBo shaker, such as “Dragon Tiger”, “running light game (Little Mary; Mario slot machine)”, “Sedie”, and so on.

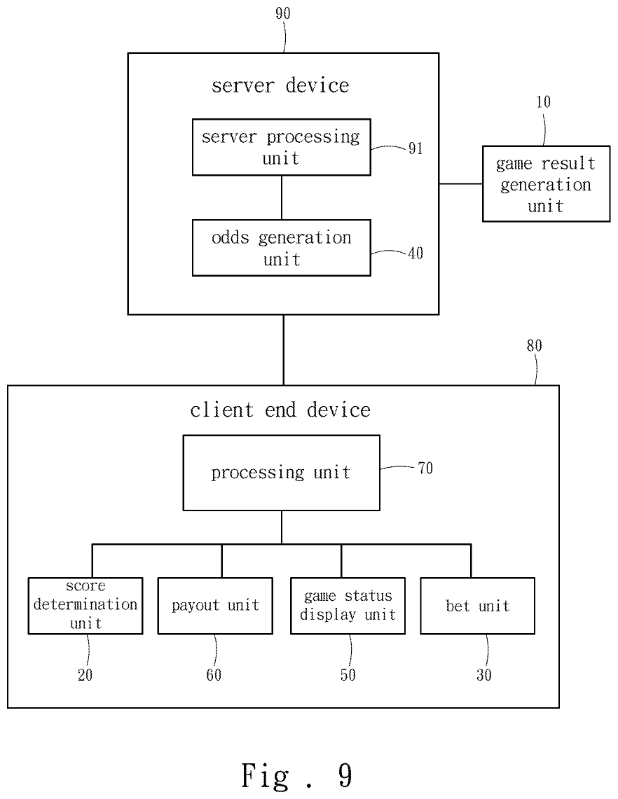

Please refer to FIG. 9 for another architecture diagram of the game system of the present invention. The game result generation unit 10 is a machine device with a physical body. The odds generation unit 40 is disposed in a server device 90. The score determination unit 20, the bet unit 30, the game status display unit 50, the payout unit 60 and the processing unit 70 are disposed in the client end device 80. The game result generation unit 10 is connected to the server device 90. The server device 90 is connected to the client end device 80. The server device 90 further includes a server processing unit 91 connected to the odds generation unit 40 wherein the server processing unit 91 receives a signal from the processing unit 70 in order to control the odds generation unit 40 to generate the random odds 522 and the additional random odds 523 (as shown in FIG. 4C), the odds generation unit 40 transmits the random odds 522 and the additional random odds 523 back to the processing unit 70, and the server processing unit 91 obtains the plurality of game results generated by the game result generation unit 10 and transmits the plurality of game results to the processing unit 70. In this embodiment, the server processing unit 91 is able to correspond to the client end devices 80, that is, the odds generation unit 40 is able to uniformly control the client end devices 80 to prevent cheating by artificial modification.

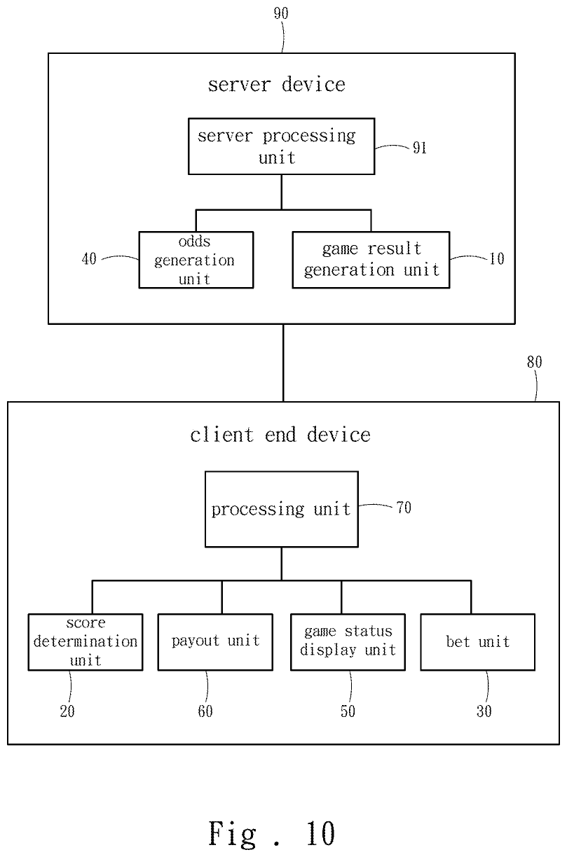

Please refer to FIG. 10, which is another architecture diagram of the game system of the present invention, wherein the game result generation unit 10 is a random number generating unit, and the game result generation unit 10 and the odds generation unit 40 are disposed in the server device 90. The score determination unit 20, the bet unit 30, the game status display unit 50, the payout unit 60 and the processing unit 70 are disposed in the client end device 80. The server device 90 is connected to the client end device 80. The server device 90 further includes the server processing unit 91 connected to the odds generation unit 40 and the game result generation unit 10 wherein the server processing unit 91 receives a signal from the processing unit 70 and control the odds generation unit 40 to generate the random odds 522 and the additional random odds 523 (as shown in FIG. 4C), the odds generation unit 40 transmits the random odds 522 and the additional random odds of 523 back to the processing unit 70, and the game result generation unit 10 randomly generates any one of the plurality of game results and transmits any one of the plurality of game results to the processing unit 70.

In this embodiment, the game result generation unit 10 is not disposed with a physical machine so that occupied volume is effectively reduced, and the game result generation unit 10 and the odds generation unit 40 are disposed in the server device 90, which avoids the risk of intrusion by hackers.

As described above, the advantages of the present invention include at least:

1. The effect of notifying the player to place additional bets is achieved after the score determination unit determining whether the game score satisfies a score threshold value, and then the game status display unit displays the enabled status of the additional bet option.

2. The additional bet option has the reminder mode that motivates the player to place the bets.

3. After the player places the additional bets, the additional random odds are generated by the odds generation unit, which increases the probability of occurrence and a quantity of the additional random odds, and the uncertainty and fun of the game indeed increase the effectiveness of attracting the attention of the player to place the bets.

4. Each of the additional bet values of the additional bet signal is the specified percentage of the bet amount of the bet amount signal, allowing the player to directly control the bet amount.

5. A quantity of the additional random odds of the plurality of bet boxes is positively correlated to the additional bet values of the additional bet signal corresponding to the additional bet options selected by the player, so as to motivate the player to select an additional bet of a larger value.

What is claimed is:

1. A game system with additional bets and odds for extra payouts, provided for a player to play a game, wherein the game includes a plurality of game results, and the player has a game score, the game system comprising:
a game result generation unit, randomly generating any one of the plurality of game results for each round of the game;
a score determination unit, determining whether the game score satisfying a score threshold value, and accordingly generating a score determination signal;
a game status display unit, having a game display field for displaying a real-time game status, a plurality of bet boxes corresponding to the plurality of game results and a status display field, and each of the plurality of bet boxes having a basic odds;
a bet unit, provided for the player to place bets and generating a bet amount signal when the player placing the bets in the plurality of bet boxes of the game status display unit, the bet unit having an additional bet option with a changeable enabled status, and when the additional bet option being in an enabled status, the bet unit provided the player to select whether to place additional bets to generate an additional bet signal;
an odds generation unit, generating a random odds for at least one of the plurality of bet boxes, and generating an additional random odds for at least one of the plurality of bet boxes according to the additional bet signal, wherein each of the plurality of bet boxes having an actual odds which respectively corresponds to the basic odds of the plurality of bet boxes, and when both the random odds and the additional random odds being generated, the actual odds being further replaced with a new value according to the random odds and the additional random odds;
a payout unit, paying according to the plurality of game results generated by the game result generation unit, the bet amount signal of the player and the actual odds of the plurality of bet boxes, and accumulating to the game score; and
a processing unit, connected to the odds generation unit, the game result generation unit, the score determination unit, the bet unit, the game status display unit and the payout unit, the processing unit controlling a progress of the game, and the processing unit performing following steps of:
controlling the game status display unit to notify the player to start placing the bets, so that the bet unit generating the bet amount signal, and the game status display unit displaying bet amounts corresponding to the bet amount signal in the plurality of bet boxes;
controlling the score determination unit to generate the score determination signal and to transmit the score determination signal back to the processing unit;
determining whether to enable the additional bet option according to the score determination signal, and controlling the game status display unit to display the enabled status of the additional bet option in the status display field, when the additional bet option being in the enabled status, the plurality of bet boxes are provided for the player to select whether to place the additional bets and the bet unit generates the additional bet signal, and the processing unit controls the game status display unit to display the additional bets corresponding to the additional bet signal in the plurality of bet boxes;
controlling the odds generation unit to generate the random odds after the player ending the bets, controlling the odds generation unit to generate the additional random odds after the additional bet signal is generated by the bet unit, and controlling the game status display unit to display the random odds and the additional random odds in the plurality of bet boxes;
controlling the game result generation unit to generate any one of the plurality of game results; and
controlling the payout unit to pay.

2. The game system with additional bets and odds for extra payouts of claim 1, wherein a quantity of the additional bet option of the bet unit is a plurality, the additional bet options are respectively corresponding to the additional bet signals of different additional bets, and the additional bet options include different score threshold values, the score determination unit determines the score threshold values one by one, and causes the processing unit to enable the additional bet options that satisfy the score threshold value for the player to select any one of the additional bet options.

3. The game system with additional bets and odds for extra payouts of claim 2, wherein a quantity of the additional random odds of the plurality of bet boxes is positively correlated to the additional bets of the additional bet signal corresponding to the additional bet options selected by the player.

4. The game system with additional bets and odds for extra payouts of claim 3, wherein each of the additional bets of the additional bet signal is a specified percentage of a bet amount of the bet amount signal.

5. The game system with additional bets and odds for extra payouts of claim 1, wherein the status display field of the game status display unit has a reminder mode, and the status display field starts the reminder mode when the additional bet option is enabled.

6. The game system with additional bets and odds for extra payouts of claim 2, wherein the status display field of the game status display unit has a reminder mode, and the status display field starts the reminder mode when the additional bet option is enabled.

7. The game system with additional bets and odds for extra payouts of claim 1, wherein the game result generation unit is selected from any one of roulette and SicBo shaker.

8. The game system with additional bets and odds for extra payouts of claim 1, wherein the game result generation unit is a machine device with a physical body, the score determination unit, the bet unit, the odds generation unit, the game status display unit, the payout unit and the processing unit are disposed in a client end device, and the client end device is connected to the game result generation unit and causes the processing unit to obtain the plurality of game results generated by the game result generation unit.

9. The game system with additional bets and odds for extra payouts of claim 1, wherein the game result generation unit is a machine device with a physical body, the odds generation unit is disposed in a server device and the score determination unit, the bet unit, the game status display unit, the payout unit and the processing unit are disposed in a client end device, the game result generation unit is connected to the server device, the server device is connected to the client end device, and the server device further includes a server processing unit connected to the odds generation unit, the server processing unit receives a signal from the processing unit in order to control the odds generation unit to generate the random odds and the additional random odds, the odds generation unit transmits the random odds and the additional random odds back to the processing unit, and the server processing unit obtains the plurality of game results generated by the game result generation unit and transmits the plurality of game results to the processing unit.

10. The game system with additional bets and odds for extra payouts of claim 1, wherein the game result generation unit is a random number generating unit.

11. The game system with additional bets and odds for extra payouts of claim 10, wherein the game result generation unit and the odds generation unit are disposed in a server device and the score determination unit, the bet unit, the game status display unit, the payout unit and the processing unit are disposed in a client end device, the server device is connected to the client end device, the server device further includes a server processing unit connected to the odds generation unit and the game result generation unit, the server processing unit receives a signal from the processing unit and controls the odds generation unit to generate the random odds and the additional random odds, the odds generation unit transmits the random odds and the additional random odds back to the processing unit, and the game result generation unit randomly generates any one of the plurality of game results and transmits any one of the plurality of game results to the processing unit.

12. A game system with additional bets and odds for extra payouts, provided for a player to play a game, wherein the game includes a plurality of game results, and the player has a game score, the game system comprising:
a game result generation unit, randomly generating any one of the plurality of game results for each round of the game;
a score determination unit, determining whether the game score satisfying a score threshold value, and accordingly generating a score determination signal;
a game status display unit, having a game display field for displaying a real-time game status, a plurality of bet boxes corresponding to the plurality of game results, and a status display field, and each of the plurality of bet boxes having a basic odds;
a bet unit, provided for the player to place bets and generating a bet amount signal when the player placing the bets in the plurality of bet boxes of the game status display unit, the bet unit having an additional bet option with a changeable enabled status, and when the additional bet option being in an enabled status, the bet unit provided the player to select whether to place additional bets to generate an additional bet signal;
an odds generation unit, generating a random odds for at least one of the plurality of bet boxes, and generating an additional random odds for at least one of the plurality of bet boxes according to the additional bet signal, wherein each of the plurality of bet boxes having an actual odds, which respectively correspond to the basic odds of the plurality of bet boxes, and when both the random odds and the additional random odds being generated, the actual odds being further replaced with a new value according to the random odds and the additional random odds;
a payout unit, paying according to the plurality of game results generated by the game result generation unit, the bet amount signal of the player and the actual odds of the plurality of bet boxes, and accumulating to the game score; and
a processing unit, connected to the odds generation unit, the game result generation unit, the score determination unit, the bet unit, the game status display unit and the payout unit, the processing unit controlling a progress of the game, and the processing unit performing following steps of:
controlling the game status display unit to notify the player to start placing the bets so that the bet unit generating the bet amount signal, and the game status display unit displaying bet amounts corresponding to the bet amount signal in the plurality of bet boxes;
controlling the score determination unit to generate the score determination signal and to transmit the score determination signal back to the processing unit after the player ending the bets, the processing unit simultaneously controlling the odds generation unit to generate the random odds, and the processing unit controlling the game status display unit to display the random odds in the plurality of bet boxes;
determining whether to enable the additional bet option according to the score determination signal, and controlling the game status display unit to display the enabled status of the additional bet option in the status display field, when the additional bet option being in the enabled status, the player selecting whether to place the additional bets and causing the bet unit to generate the additional bet signal, and the game status display unit displaying the additional bets corresponding to the additional bet signal in the plurality of bet boxes;
controlling the odds generation unit to generate the additional random odds after the bet unit generating the additional bet signal, and the game status display unit displaying the additional random odds in the plurality of bet boxes;
controlling the game result generation unit to generate any one of the plurality of game results; and
controlling the payout unit to pay.

13. The game system with additional bets and odds for extra payouts of claim 12, wherein a quantity of the additional bet option of the bet unit is a plurality, the additional bet options are respectively corresponding to the additional bet signal with different additional bet and the additional bet options include different score threshold values, the score determination unit determines the score threshold values one by one, and causes the processing unit to enable the additional bet options that satisfy the score threshold value for the player to select any one of the additional bet options.

14. The game system with additional bets and odds for extra payouts of claim 13, wherein the plurality of bet boxes displaying a quantity of the additional random odds of the plurality of bet boxes is positively correlated to the additional bets of the additional bet signal corresponding to the additional bet options selected by the player.

15. The game system with additional bets and odds for extra payouts of claim 14, wherein each of the additional bets of the additional bet signal is a specified percentage of a bet amount of the bet amount signal.

16. The game system with additional bets and odds for extra payouts of claim 12, wherein the status display field of the game status display unit has a reminder mode, and the status display field starts the reminder mode when the additional bet option is enabled.

17. The game system with additional bets and odds for extra payouts of claim 13, wherein the status display field of the game status display unit has a reminder mode, and the status display field starts the reminder mode when the additional bet option is enabled.

18. The game system with additional bets and odds for extra payouts of claim 12, wherein the game result generation unit is selected from any one of roulette and SicBo shaker.

19. The game system with additional bets and odds for extra payouts of claim 12, wherein the game result generation unit is a machine device with a physical body, the score determination unit, the bet unit, the odds generation unit, the game status display unit, the payout unit and the processing unit are disposed in a client end device, and the client end device is connected to the game result generation unit and causes the processing unit to obtain the plurality of game results generated by the game result generation unit.

20. The game system with additional bets and odds for extra payouts of claim 12, wherein the game result generation unit is a machine device with a physical body, the odds generation unit is disposed in a server device and the score determination unit, the bet unit, the game status display unit, the payout unit and the processing unit are disposed in a client end device, the game result generation unit is connected to the server device, the server device is connected to the client end device, and the server device further includes a server processing unit connected to the odds generation unit, the server processing unit receives a signal from the processing unit in order to control the odds generation unit to generate the random odds and the additional random odds, the odds generation unit transmits the random odds and the additional random odds back to the processing unit and the server processing unit obtains the plurality of game results generated by the game result generation unit, and transmits the plurality of game results to the processing unit.

21. The game system with additional bets and odds for extra payouts of claim 12, wherein the game result generation unit is a random number generating unit.

22. The game system with additional bets and odds for extra payouts of claim 21, wherein the game result generation unit and the odds generation unit are disposed in a server device, and the score determination unit, the bet unit, the game status display unit, the payout unit and the processing unit are disposed in a client end device, the server device is connected to the client end device, the server device further includes a server processing unit connected to the odds generation unit and the game result generation unit, the server processing unit receives a signal from the processing unit and controls the odds generation unit to generate the random odds and the additional random odds, the odds generation unit transmits the random odds and the additional random odds back to the processing unit, and the game result generation unit randomly generates any one of the plurality of game results and transmits any one of the plurality of game results to the processing unit.
